(19) United States
(12) Patent Application Publication
(10) Pub. No.: US 2009/0295910 A1
(43) Pub. Date: Dec. 3, 2009

(54) Hyperspectral Imaging System and Methods Thereof

(76) Inventors: Jose Mir, Rochester, NY (US); Dennis Zander, Penfield, NY (US)

Correspondence Address: Jaekle Fleischmann & Mugel, LLP, 12 Fountain Plaza, Buffalo, NY, 14202-2292, US

(21) Appl. No.: 11/912,361

(22) PCT Filed: Mar. 24, 2006
(86) PCT No.: PCT/US2006/010972

§ 371 Date: Oct. 23, 2007

Related U.S. Application Data
(60) Provisional application No. 60/664,743, filed on Mar. 24, 2005.
(60) Provisional application No. 60/670,149, filed on Apr. 11, 2005.

(51) Int. Cl. H04N 7/18

(52) U.S. Cl. 348/61; 348/E07.085

(57) ABSTRACT

A hyperspectral imaging system and methods thereof especially useful in fields such as medicine, food safety, chemical sensing, and agriculture, for example. In one embodiment, the hyperspectral imaging module contains a light source (1) for illuminating the object (6) in a light-tight housing (17). The light is spectrally filtered (4) prior to illuminating the object. The light leaving the object is then directed through imaging optics (T) to an imaging array (9). In another embodiment, the object of interest is illuminated by ambient light which is then compensated by a light modulation system. In this embodiment, the light emitted from the object is spectrally filtered prior to reaching the imaging array.

### FIELD OF THE INVENTION

The present invention generally relates to imaging systems and, more particularly, to hyperspectral imaging systems and methods thereof.

### BACKGROUND

Hyperspectral imaging is increasing its use in a number of applications such as remote sensing, agriculture, food safety, homeland security, and medicine. The approach typically involves the use of dispersive optical elements (e.g. prisms or gratings), lenses or mirrors, spatial filters or stops (e.g. slits), and image sensors able to capture image content at multiple wavelengths. The resulting data is often formatted electronically as a “data cube” consisting of stacked 2D layers corresponding to the imaged surface, each stack layer corresponding to a particular wavelength or narrow band of wavelengths. Due to their complexity, these systems are expensive and have large physical dimensions. They often require complex calibration and compensation to account for changing ambient illumination conditions.

### SUMMARY

The present invention provides systems and methods to image map surfaces hyperspectrally using low cost, compact microsystems. In a preferred embodiment, there are substantially no moving parts or complex dispersive optical elements that require long optical throws. In another embodiment, the environment around the hyperspectral imaging module is light tight, thereby minimizing illumination variations due to ambient conditions. A novel calibration technique may be used in cases where a light tight environment may not be practical to achieve. The configuration may be further enhanced by using a second imager to obtain topographic information for the surface being analyzed. Due to these and other advantages, the invention is especially useful in fields such as medicine, food safety, chemical sensing, and agriculture, for example.

### BRIEF DESCRIPTION OF THE DRAWINGS

FIG. 1 is a block diagram of a hyperspectral imaging system in accordance with embodiments of the present invention;

FIG. 2 is a block diagram of a hyperspectral imaging system in accordance with embodiments of the present invention;

FIG. 3 is a block diagram of a calibration system for use with a hyperspectral imaging system in accordance with embodiments of the present invention;

FIG. 4 is a top view of a compact handheld hyperspectral imaging system in accordance with embodiments of the present invention;

FIG. 5 is a side view of the compact handheld hyperspectral imaging system shown in FIG. 4;

FIGS. 6A-6D are diagrams of a hyperspectral imaging accessory for use with a processing system;

FIG. 7 is a block diagram of a hyperspectral imaging system in accordance with a further embodiment of the present invention;

FIG. 8A is a block diagram of a hyperspectral module in accordance with yet a further embodiment of the present invention;

FIG. 8B is an enlarged view of a portion of the hyperspectral module shown in FIG. 8A;

FIG. 9 is a block diagram of yet a further embodiment of the present invention;

FIG. 10 is a further embodiment of the present invention; and

FIG. 11 is a further embodiment of the present invention.

### DETAILED DESCRIPTION

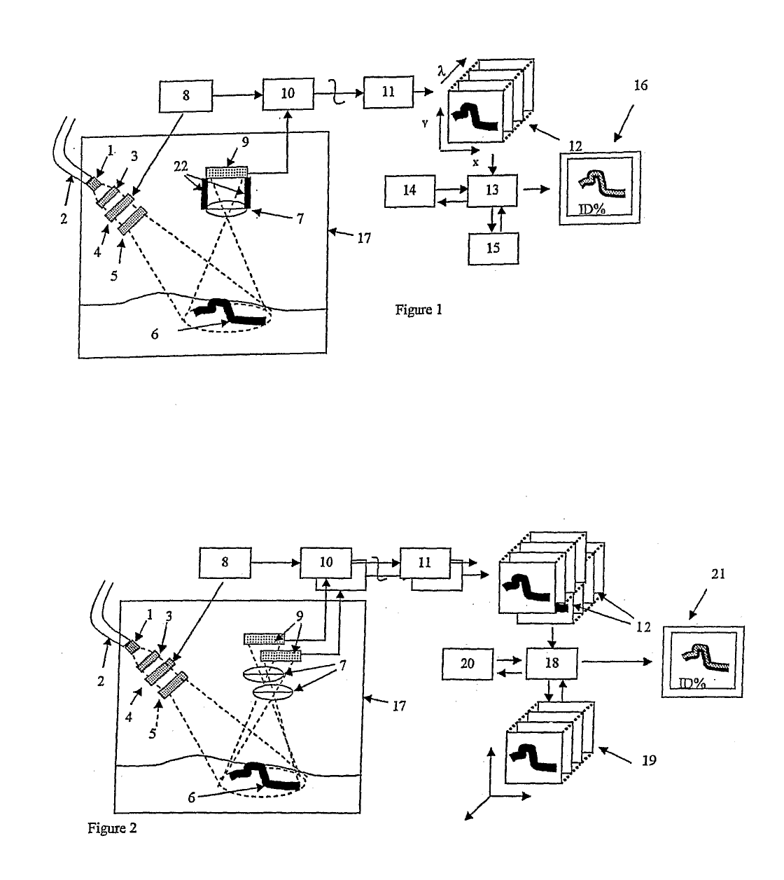

Referring to FIG. 1, a hyperspectral imaging system in accordance with an embodiment of the present invention is illustrated. Light from a polychromatic light source 1 or fiber optic illumination 2 is substantially collimated by a lens or gradient index GRIN collimator 3. Electronically controlled narrow band spectral filter 4 filters the collimated light to produce a beam with the central wavelength thereof determined by wavelength controller 8. Beam expander 5 expands the filtered, collimated beam so as to fully illuminate feature or surface of interest 6. Imaging lens 7 projects an image of illuminated feature or surface of interest 6 onto sensor array 9. It may thus be realized that in the embodiment of FIG. 1, the object light is spectrally filtered prior to imaging by imaging lens 7. Furthermore, the entire system is enclosed by light-tight housing or dark box 17 to minimize the effect of ambient light on the surface being analyzed. If desired or required, additional illumination systems comprising of elements 1-5 may be placed around lens 7 to improve the uniformity of illumination incident on feature or surface of interest 6.

Light source 1 may be any polychromatic emissive element with emission spectrum covering the wavelength range of interest. Examples include small filament incandescent bulbs, broad spectrum LED's (e.g. phosphor-enhanced GaAlN emitters), output facet of multimode optical fibers, and others.

Spectral filter 4 may be any device that passes a narrow spectral band using electronic control. A useful device for this purpose is a microspectrometer based on Fabry-Perot interferometer described in U.S. Pat. No. 6,295,130 to Sun et al, the entire disclosure of which is incorporated herein by reference.

As stated above, one of the advantages of the hyperspectral imaging system of the embodiment of FIG. 1 is that it may be provided in a relatively small, compact unit. Although final total dimensions of the system depend on the specific application and design features being employed, the optical train comprising components 1-5 may be provided in a space that is as small as between about 1 to 5 mm in width and between about 4 to 20 mm in length, for example. This is a significant improvement over the much larger optical train dimensions of prior art hyperspectral imaging systems.

After image capture by sensor array 9, the output signal is formatted and stored by data processing system 10. Data processing system 10 indexes the captured image data corresponding to each central wavelength transmitted by filter 4. Image data including central wavelength information as metadata is transmitted by wire or by wireless means to spectral processing engine 11. The process may be repeated at several wavelength bands to create a “data cube” 12, a representation of x-y image data sets stacked as layers corresponding to wavelength bands. Hyperspectral processing system 13 may be provided to analyze data cube information 12, selecting and enhancing specific wavelength image layers for analysis and optional display.

The hyperspectral processing system 13 may include a central processing unit (CPU) or processor and a memory which may be coupled together by a bus or other link, although other numbers and types of components in other configurations and other types of systems, such as an ASIC could be used. The processor executes a program of stored instructions for one or more aspects of the present invention as described and illustrated herein, including the methods for hyperspectral imaging as described and illustrated herein. The memory stores these programmed instructions for execution by the processor. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory to store these programmed instructions.

The selection and processing of wavelength layer images by hyperspectral processing system 13 may be made to correlate with a specific application for which the hyperspectral imaging system is being used. For example, infrared wavelength layers may be used to reveal internal features since the depth of penetration of certain media is greater in the infrared than in the visible. Furthermore, wavelength layers corresponding to absorption of specific chemical species, diseased states, or lesions, for example, may be chosen and accentuated for analysis and display.

Display 16 may be used to view hyperspectral image data either in real time or after processing by hyperspectral processing system 13. Data from the wavelength layers of interest may be displayed by display 16 either matching the captured wavelength colors by mapping them to other colors that may accentuate the presence of the feature or surface of interest. Additional displays may be used remotely or physically attached to housing 17. A display 16 attached or local to housing 17 may also serve as an alignment aid or feature locator to center the image of feature or surface of interest 6 on the sensor array 9. Light baffles 22 may be included to keep flare light away from the sensor array 9.

Further information can be extracted from data cube 12 by comparing the hyperspectral data processed by hyperspectral processing system 13 with hyperspectral reference database 14. Comparison of feature morphology and color with hyperspectral database 14 can be used to identify and match feature of interest 6 with known stored data, such as areas of varying chemical composition and morphology. Based on the degree of match, one or more identifications and associated probabilities may be output and displayed on display 16. The data processed by hyperspectral processing system 13 may also be stored by storage device 15 and retrieved at a later time for further analysis, display, or comparison with new data. Changes in feature or surface of interest 6 may be monitored by digitally subtracting previously stored information from current information. Temporal information can also be used to track changes and progress of feature or surface of interest 6 quantitatively and with visual feedback provided by display 16.

The system shown in FIG. 1 may be used to create data cubes corresponding to x-y-λ where x, y are spatial coordinates and λ is wavelength. Hyperspectral analysis in the field of dermatology, for example, may be used to diagnose lesions based on shape, size, and coloration. For example, data cubes describing x-y-λ data may be correlated to patterns due to malignant melanomas or benign Seborrheic keratoses. In agriculture and food safety, degree of ripeness, food damage, spoilage, or bacterial presence may be revealed and monitored. A number of other applications in the areas of counterfeiting, microscopy, and homeland security, etc. are also possible.

The x-y-λ data cubes of FIG. 1 do not provide information related to topography. Some features such as nodular melanomas, infected wounds, rashes and other exhibit characteristic topographical elements and colors. It would be useful to obtain x-y-z-λ hyperspectral data that would more completely represent dermatological, oral and other types of lesions. The stereoscopic approach shown in FIG. 2 may be used to obtain topographic and hyperspectral information simultaneously.

The stereoscopic system shown in FIG. 2 resembles FIG. 1, except the system in FIG. 2 includes dual imaging lenses 7 and image sensors 9 that are offset in order to capture views of the feature or surface of interest 6 from different perspectives. Elements in FIG. 2 which are like those in FIG. 1 will have like reference numerals and will not be described again in detail here. Correspondingly, there are two data processing systems 10 and two spectral processing engines 11 that process data pertaining to each perspective. The two data cubes corresponding to each perspective are analyzed by 3D processing system 18 to create a single data cube 19 that contains x-y-z-λ information. Data cube 19 properties may be compared to reference samples in database 20 to find the best match for the feature or surface of interest. The 2D or 3D or stereoscopic display 21 may be used to view the hyperspectral information.

Each of the data processing systems 10, the spectral processing engines 11, and the 3D processing system 18 may include a central processing unit (CPU) or processor and a memory which are coupled together by a bus or other link, although other numbers and types of components in other configurations and other types of systems, such as an ASIC could be used. Each processor executes a program of stored instructions for one or more aspects of the present invention as described and illustrated herein, including the methods for hyperspectral imaging as described and illustrated herein. The memory stores these programmed instructions for execution by the processor. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory to store these programmed instructions.

In some cases it may not be desirable or convenient to provide a light tight environment for image capture. For example, the subject may be large, irregular, distant or too delicate for housing 17 to be used. Since ambient illumination affects the color and intensity of captured images, the environment external to housing 17 must be dark if housing 17 were eliminated from the system. Since this causes inconvenience to the subject and user of the system, it does not provide a practical solution.

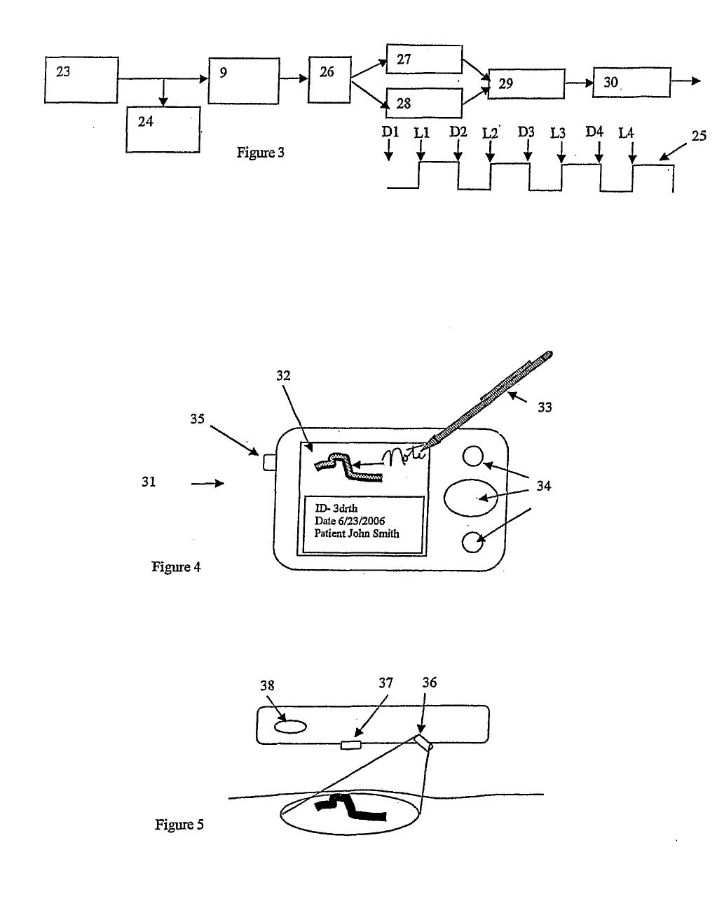

Referring to FIG. 3, a particularly effective system and method is illustrated to reduce the need for housing 17. In this embodiment, signal generator 23 provides a signal to light modulator 24 that controls the intensity of light source 1 or the light transmitted by fiber 2. The intensity of the modulated light at the subject will vary from high to low as shown by 25 at the wavelength determined by wavelength controller 8. Signal generator 23 provides a capture signal to sensor array 9 such that it triggers image capture at the start of each dark (Dn) and light (Ln) cycle shown in 25. The signals are digitized by A/D 26 and provided to dark and light image buffers 27 and 28. Buffers 27 and 28 take turns storing images captured during their respective part of the cycle. The difference between light and dark is calculated by 29 and subsequently averaged by calibration processing system 30. The output of calibration processing system 30 provides an averaged, integrated signal over the corresponding number of light/dark cycles actuated (example shows 4). Since sensor 9 is measuring the intensity of both the modulated signal and the ambient light, the output of calibration processing system 30 will represent the true hyperspectral captured information, lacking the contribution of ambient light. Depending on the requirements of the system, the difference between light and dark captured images may be done each time an image is captured or after each respective light and dark image sets are captured. To avoid effects due to motion during capture, each captured image may be compared with the previous image capture and digitally shifted to ensure that there is good registration between images. Due to the multiple images being captured, improved signal-to-noise will be achieved by increasing the number of light/dark cycles used for capture at each wavelength. The number of light/dark cycles can be varied from 1-n.

Referring to FIG. 4, a top view compact handheld hyperspectral imaging system 31 with complete optical and electronic subsystems is shown. A display 32 shows a number of critical information including processed and real time images of feature or surface of interest 6. Annotations may be added by the system user using stylus 33 which may become part of an associated record. A set of buttons 34 may be used to control system functions. The compact system may also include wireless capability with communication system 35 to communicate results, to access remote hyperspectral image databases, or other pertinent information (e.g. patient data).

Referring to FIG. 5, a side view of the system, including feature or surface of interest 6 being monitored is shown. Light source 36 illuminates the feature or surface of interest 6 according to the prescribed protocol defined previously. Additional illumination sources may be employed if a different light distribution or greater light uniformity is needed or desired. Sensor 37 captures images from the illuminated feature and processed to a display as shown at 32 in FIG. 4. Control button 38 may be used to initiate the image capture sequence.

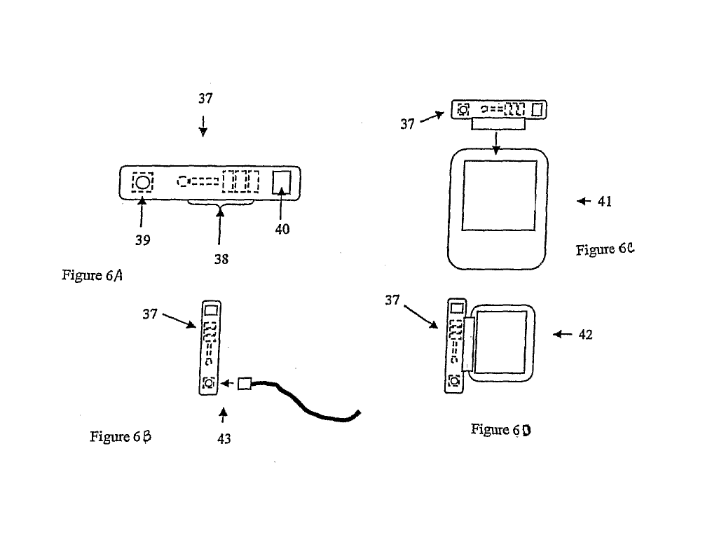

Referring to FIGS. 6A-6D, a hyperspectral imaging system accessory 37 which can be integrated with other imaging/computing devices is illustrated. Accessory 37 includes a light source subsystem 38 including elements 1-5 as shown in FIG. 1 and capture subsystem 39 that includes elements 7, 9, 22 as shown in FIG. 1. An aperture with beam steering optics 40 may comprise a mirror that steers a beam produced by subsystem 38 toward the region of interest. The hyperspectral imaging accessory 37 may be integrated onto several imaging/computing devices such as PDA/cellular phone 41, digital video recorder 42, stand-alone peripheral connected to computing system via cable interface 43. In all these cases, the power source may be provided via the imaging computing device, interface cable, or batteries internal to 37.

In some cases, it may not be practical or possible to control the spectral properties of light that illuminates an object. For example, the object might be remotely located, or it may not possible to achieve sufficiently high intensities of spectrally-controlled illumination (relative to the background) so as to achieve desired signal-to-noise ratios. Fortunately, in these cases, other ambient light sources that are spectrally broad such as incandescent light and sunlight may be used in accordance with a further embodiment of the present invention.

FIG. 7 depicts a hyperspectral imaging system that is particularly useful when spectral control of the illumination is not practical, desired, or possible. Electronically controlled narrow band spectral filter 100′ filters light entering imaging lens or lens train 300 to produce a beam, with the central wavelength or wavelength band determined by wavelength controller 200. Imaging lens or lens train 300 projects an image of illuminated feature or surface of interest 500 onto sensor array 400. Spectral filter 100′ may be any device that passes narrow spectral band using electronic control. A useful device for this purpose is a MEMs based microspectrometer based on Fabry-Perot interferometer described in U.S. Pat. No. 6,295,130 to Sun et al. It should be appreciated that other designs for electronically controlled narrow band spectral filters may be used as long as they exhibit the desired physical form factor and optical properties.

After image capture, the signal from sensor array 4 may be formatted and stored by data processing system 600. Data processing system 600 indexes the captured image data corresponding to each central wavelength transmitted by 100′. Image data including central wavelength information as metadata is transmitted by wire or by wireless means to spectral processing engine 700. The process is repeated at several wavelengths to create a “data cube” 800, a representation of x-y image data sets stacked as wavelength layers.

The data processing system 600 and the spectral processing engine 700 each comprise a central processing unit (CPU) or processor and a memory which are coupled together by a bus or other link, although other numbers and types of components in other configurations and other types of systems, such as an ASIC could be used. Each processor may execute a program of stored instructions for one or more aspects of the present invention as described and illustrated herein, including the methods for hyperspectral imaging as described and illustrated herein. The memory stores these programmed instructions for execution by the processor. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory to store these programmed instructions.

Hyperspectral processing system 900 analyzes data cube information 800, selecting and enhancing specific wavelength image layers for analysis and display. The hyperspectral processing system 900 comprises a central processing unit (CPU) or processor and a memory which are coupled together by a bus or other link, although other numbers and types of components in other configurations and other types of systems, such as an ASIC could be used. The processor executes a program of stored instructions for one or more aspects of the present invention as described and illustrated herein, including the methods for hyperspectral imaging as described and illustrated herein. The memory stores these programmed instructions for execution by the processor. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory to store these programmed instructions.

The selection and processing of wavelength layer images by hyperspectral imaging system 900 depends on the specific application. For example, infrared wavelength layers may be used to reveal internal features since the depth of penetration is greater in the infrared in certain media than in the visible. Wavelength layers corresponding to absorption of specific chemical species, diseased states, lesions, depending on the application may be chosen and accentuated for analysis and display.

Display 100′ may be used to view hyperspectral image data either in real time or after processing by hyperspectral imaging system 900. Data from the wavelength layers of interest may be displayed by display 100′ either matching the captured wavelength colors by mapping them to other colors that may accentuate the presence of a specific chemical or feature. Additional displays may be used remotely or physically attached to imaging module 110. A display attached or local to module 110 may also serve as an alignment aid or feature locator to center the image of feature or surface of interest 500 on the sensor array 400. Light baffles 120 may be included to keep flare light away from 900.

Further information can be extracted from data cube 800 by comparing the hyperspectral data processed by hyperspectral imaging system 900 with hyperspectral reference database 130. Comparison of feature morphology and color with hyperspectral database 130 can be used to identify and match feature of interest 500 with known elements. Based on the degree of match, one or more ID's and associated probabilities may be output and displayed on display 100′. The data processed by hyperspectral imaging system 900 may also be stored by storage device 140 and retrieved at a later time for further analysis, display, or comparison with new data.

Changes in feature of interest 500 may be monitored by digitally subtracting previously stored information from current information. Temporal information can be used to track changes and progress of feature of interest 500 quantitatively and with visual feedback provided by display 100′.

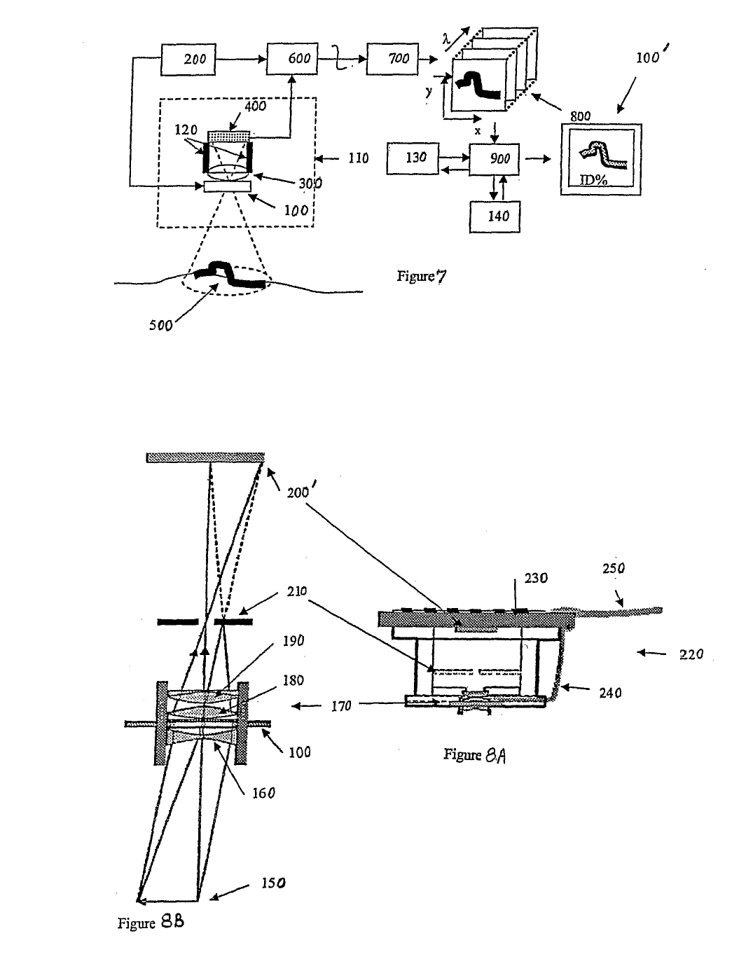

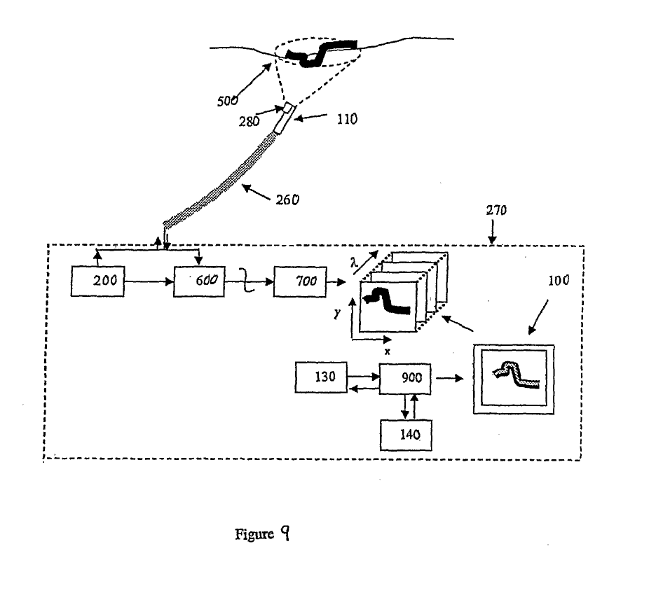

Although a single imaging module 110 is shown in the hyperspectral imager shown in FIG. 8, other numbers and types of imaging modules could be used. For example, multiple imaging modules 110 could be used to capture data from which topographical or three-dimensional information can be extracted about the object being imaged as described above In another example, multiple imaging modules could be used in a hyperspectral imager with each of the imaging modules capturing adjacent or different wavelength ranges, such as visible and infrared, for example.

FIGS. 8A and 8B show further embodiments of hyperspectral imaging module 220. Light from object plane 150 is incident onto negative lens or lens train 160 such that some of the incident light is substantially collimated prior to being directed through electronically controlled narrow band spectral filter 100. Collimation may be required when spectral filters such as the Fabry-Perot MEMS device described in U.S. Pat. No. 6,295,130 to Sun et al. are used. Spectral filter 100 is preferably positioned between 160 and a positive lens or lens train 180 that reduces the optical power of negative lens or lens train 160. In a specific example, 180 may have approximately the same focal length as 160 (but of opposite sign) thereby substantially neutralize the optical power of imaging lens 160. Lenses 160 and 180 may comprise one or more individual lenses to control imaging properties, such as chromatic aberration, distortion, etc.

Imaging lens or lens train 190 projects an image of object 150 onto sensor array 200′. Sensor array 200′ is located relative to lenses 160, 180, and 190 such that a sharp image of object 150 is achieved at 200′. A spatial filter or stop 210 may be included in the optical train to only image light rays at 200′ that were within a desired angular range at filter 100. In a specific example, 210 may be placed at approximately the focal point of the combination of lenses 180, and 190. In this case, a very small stop aperture 210 will only allow image rays reaching 200′ that were substantially collimated at filter 100. It should be apparent to those skilled in the art that 210 may be located elsewhere in the optical train, as long as it limits image light rays at 200′ that are within the desired angular range at filter 100.

An example of a substantially completely packaged hyperspectral module 220 is shown in FIG. 8A. In this configuration, sensor array 200′ is mounted on electronic control board 230 that may include associated wiring, interconnects, and control electronics. Interconnect 240 connects the electronic input needed to modify the spectral property of spectral filter 100 with the electronic control board 230. Signals are input and output from the hyperspectral imaging module by connection 250.

Due to the compactness and fully integrated functions of the embodiment, the module may be used to enable hyperspectral imaging capability on a number of device modalities such as compact computers, cameras, cellular phones, and others such as described above.

A further embodiment of the present invention integrates the hyperspectral imaging module on the sensing end of an endoscope as shown in FIG. 9. Hyperspectral imaging module 110 is located at the end of carrier 260 that carries control, signal, and data signals to and from electronic control system 270. An additional light source 280 may be included as part of 110 if auxiliary illumination is desired or required to capture images of region of interest 500.

Of course, one can envision a requirement where one uses a controllable filter with a broadband light source to illuminate the subject with light of wavelength λ₁, and one wishes to detect the response to λ, at one or more different wavelengths λ₂, λ₃, etc. For example, where the illuminant is an ultraviolet wavelength and that illuminating source stimulates a fluorescing response at one or more secondary wavelengths. This creates a hyperspectral imaging system with a controlled filter light source and independently controlled filtered image sensor.

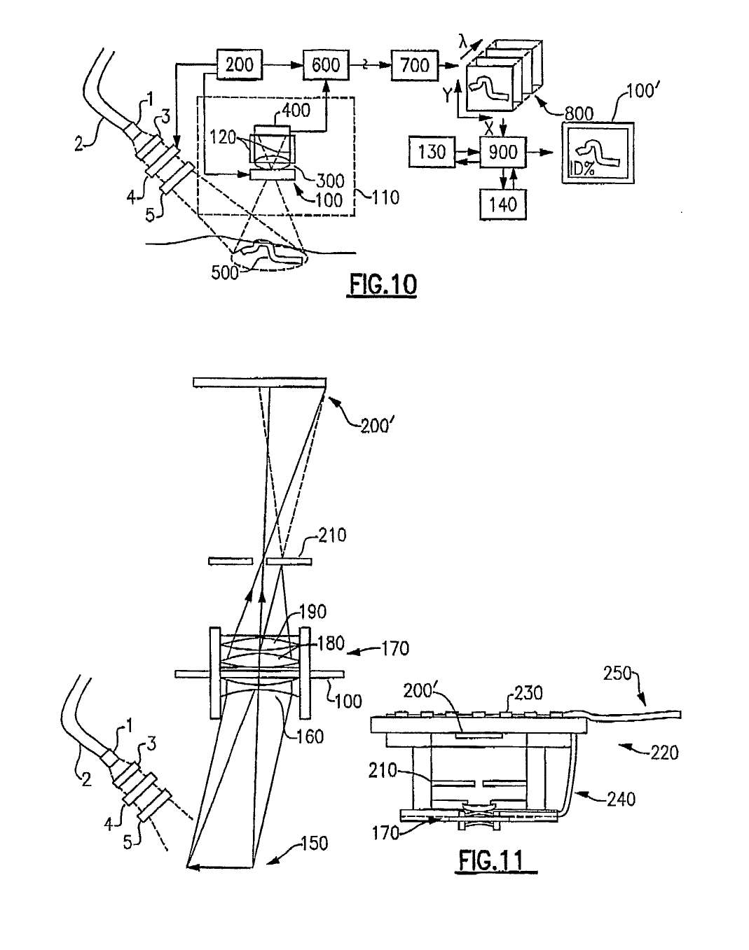

Possible embodiments incorporating this aspect of the invention are seen in FIGS. 10 and 11, wherein like numerals have been used to represent like parts with previously illustrated and described embodiments herein.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A spectral imaging system comprising:
a) a light source;
b) an optical system for directing a beam of light from the light source towards an object;
c) a spectral filtering element placed in the path of the light beam, said spectral filtering element being selectively controllable to pass only a predetermined narrow wavelength band of the entire light beam;
d) an imaging system positioned to capture image information about the object as illuminated by the predetermined narrow wavelength band of the light beam; and
e) a light-tight housing in which said optical system, said spectral filtering element and said imaging system are contained.

2. The system as set forth in claim 1 wherein said light source is polychromatic.

3. The system as set forth in claim 1 further comprising a processing system for outputting data about said image information.

4. A spectral imaging system comprising:
a) a light source;
b) an optical system that directs a beam of light from the light source towards an object;
c) a spectral filtering element placed in the path of the light beam, said spectral filtering element being selectively controllable to pass only a predetermined narrow wavelength band of the entire light beam;
d) an imaging system positioned to capture image information about the object as illuminated by the predetermined narrow wavelength band of the light beam; and
e) a light modulation and processing system which determines an ambient light contribution from the captured image information and adjusts the captured image information based on the determined ambient light contribution.

5. The system as set forth in claim 1 wherein the imaging system further comprises:
at least one array image sensor; and
at least one imaging optics system positioned to direct the image information about the object as illuminated by the predetermined narrow wavelength band of the light beam on to at least a portion of the array image sensor.

6. The system as set forth in claim 5 and further comprising a pair of the array image sensors and a pair of the imaging optics system, each of the pair of imaging optics systems being positioned to direct the image information about the object illuminated by the predetermined narrow wavelength band of the light beam on to at least a portion of one of the pair of array image sensors.

7. The system as set forth in claim 1 and further comprising a processing system for outputing data about the object based on an analysis of the topography of the image information about the object as illuminated by the predetermined narrow wavelength band of the light beam.

8. The system as set forth in claim 1 and further comprising one or more reference data bases containing image data and a processing system for outputting diagnosis data about the object based on the image information when compared against image data stored in the one or more reference databases.

9. The system as set forth in claim 1 wherein said light-tight housing is a handheld housing.

10. The system as set forth in claim 1 wherein said spectral filtering element is a Fabry-Perot filtering element and further comprising a collimator positioned between said light source and said Fabry-Perot filtering element, said collimator adapted to substantially collimate the light from the light source prior to the light entering the Fabry-Perot filtering element.

11. The system of claim 10 and further comprising a beam expander positioned between said Fabry-Perot filtering element and said object.

12. The system of claim 11 wherein said light source, said collimator, said Fabry-Perot filtering element and said beam expander, when positioned in operable relationship in said hyperspectral imaging system, are collectively in the range of between about 3 mm to about 20 mm long and between about 1 mm to about 5 mm wide.

13. A method for spectral imaging comprising the steps of:
a) providing a light source;
b) providing an optical system for directing a beam of light from the light source towards an object;
c) providing a spectral filtering element placed in the path of the light beam, said spectral filtering element being selectively controllable to pass only a predetermined narrow wavelength band of the entire light beam;
d) providing an imaging system positioned to capture image information about the object as illuminated by the predetermined narrow wavelength band of the light beam; and
e) providing a light-tight housing in which said optical system, said spectral filtering element and said imaging system are contained.

14. The method as set forth in claim 13 wherein said light source is polychromatic.

15. The method as set forth in claim 13 and further comprising the step of providing a processing system for outputting data about said image information.

16. A method of spectral imaging comprising the steps of:
a) providing a light source;
b) providing an optical system that directs a beam of light from the light source towards an object;
c) providing a spectral filtering element placed in the path of the light beam, said spectral filtering element being selectively controllable to pass only a predetermined narrow wavelength band of the entire light beam;
d) providing an imaging system positioned to capture image information about the object as illuminated by the predetermined narrow wavelength band of the light beam; and
e) providing a light modulation and processing system which determines an ambient light contribution from the captured image information and adjusts the captured image information based on the determined ambient light contribution.

17. The method as set forth in claim 16 wherein the imaging system further comprises:
at least one array image sensor; and
at least one imaging optics system positioned to direct the image information about the object as illuminated by the predetermined narrow wavelength band of the light beam on to at least a portion of the array image sensor.

18. The method as set forth in claim 17 and further comprising the step of providing a pair of the array image sensors and a pair of the imaging optics system, each of the pair of imaging optics systems being positioned to direct the image information about the object illuminated by the predetermined narrow wavelength band of the light beam on to at least a portion of one of the pair of array image sensors

19. The method as set forth in claim 16 and further comprising the step of providing a processing system for outputting data about the object based on an analysis of the topography of the image information about the object as illuminated by the predetermined narrow wavelength band of the light beam.

20. The method as set forth in claim 16 and further comprising the step of providing one or more reference data bases containing image data and a processing system for outputting diagnosis data about the object based on the image information when compared against image data stored in the one or more reference databases.

21. The method as set forth in claim 16 wherein said light-tight housing is a handheld housing.

22. The method as set forth in claim 16 wherein said spectral filtering element is a Fabry-Perot filtering element and further comprising the step of providing a collimator positioned between said light source and said Fabry-Perot filtering element, said collimator adapted to substantially collimate the light from the light source prior to the light entering the Fabry-Perot filtering element.

23. The method as set forth in claim 22 and further comprising the step of providing a beam expander positioned between said Fabry-Perot filtering element and said object.

24. The system as set forth in claim 23 wherein said light source, said collimator, said Fabry-Perot filtering element and said beam expander, when positioned in operable relationship in said hyperspectral imaging system, are collectively in the range of between about 3 mm to about 20 mm long and between about 1 mm to about 5 mm wide.

25. A spectral imaging system for spectrally imaging an illuminated object, said system comprising:
a) a spectral filtering system selectively controllable to pass only a predetermined narrow wavelength band of light received from the object;
b) an imaging system positioned to capture image information about the object, said imaging system including:
i) a first lens or lens train;
ii) a second lens or lens train, the spectral filtering system positioned between the first and second lenses or lens trains; and
iii) a third lens or lens train, the second lens or lens train positioned between the spectral filtering system and the third lens or lens train.

26. The system as set forth in claim 25 wherein the first lens or lens train is a negative lens or lens train and the second lens or lens train is a positive lens or lens train.

27. The system as set forth in claim 25 and further comprising a processing system for outputting data about said image information.

28. The system as set forth in claim 27 wherein the processing system processes and outputs data about the object based on an analysis of the topography of the image information.

29. The system as set forth in claim 25 wherein the imaging system further comprises at least one light baffle positioned about at least a portion of the first lens or lens train, the second lens or lens train, and the third lens or lens train.

30. The system as set forth in claim 25 wherein the imaging systems comprises two or more of the imaging systems with each of the imaging systems capturing image information about the object at a substantially different wavelength band.

31. The system as set forth in claim 25 and further comprising a reference data base containing image data and wherein the processing system processes and outputs diagnosis data about the object based on the image information when compared against image data stored in one or more reference databases.

32. The system as set forth in claim 25 wherein the processing system processes and outputs temporal data illustrating one or more changes in the object.

33. The system as set forth in claim 25 and further comprising a portable housing which is positioned around at least the spectral filtering system and the imaging system.

34. The system as set forth in claim 25 wherein the imaging system comprises at least one image array sensor positioned to receive the image information about the object at the wavelength band from the third imaging lens.

35. The system as set forth in claim 25 wherein the imaging system further comprises at least one spatial filter or stop positioned at the third lens or lens train or between the third lens or lens train lens and the image array sensor.

36. The system as set forth in claim 25 wherein said spectral filtering element is a Fabry-Perot filtering element and said first lens or lens train is negative and substantially collimates a portion of the light before it enters the Fabry-Perot filtering element.

37. The system as set forth in claim 35 wherein said spectral filtering element is a Fabry-Perot filtering element and said first lens or lens train has negative power and substantially collimates a portion of the light before it enters the Fabry-Perot filtering element.

38. A method of spectral imaging an illuminated object, said method comprising the steps of:
a) providing a spectral filtering system selectively controllable to pass only a predetermined narrow wavelength band of light received from the object;
b) providing an imaging system positioned to capture image information about the object, said imaging system including:
i) a first lens or lens train;
ii) a second lens or lens train, the spectral filtering system positioned between the first and second lenses or lens trains; and
iii) a third lens or lens train, the second lens or lens train positioned between the spectral filtering system and the third lens or lens train.

39. The method as set forth in claim 38 wherein the first lens or lens train is negative and the second lens or lens train is positive.

40. The method as set forth in claim 38 and further comprising the step of providing a processing system for outputting data about said image information.

41. The method as set forth in claim 40 wherein the processing system processes and outputs data about the object based on an analysis of the topography of the image information.

42. The method as set forth in claim 38 wherein the imaging system further comprises at least one light baffle positioned about at least a portion of the first lens or lens train, the second lens or lens train, and the third lens or lens train.

43. The method as set forth in claim 38 wherein the imaging system comprises two or more of the imaging systems with each of the imaging systems capturing image information about the object at a substantially different wavelength band.

44. The method as set forth in claim 38 and further comprising the step of providing a reference data base containing image data and wherein the processing system processes and outputs diagnosis data about the object based on the image information when compared against image data stored in one or more reference databases.

45. The method as set forth in claim 38 wherein the processing system processes and outputs temporal data illustrating one or more changes in the object.

46. The method as set forth in claim 38 and further comprising the step of providing a portable housing which is positioned around at least the spectral filtering system and the imaging system.

47. The method as set forth in claim 38 wherein the imaging system comprises at least one image array sensor positioned to receive the image information about the object at the wavelength band from the third imaging lens.

48. The method as set forth in claim 38 wherein the imaging system further comprises at least one spatial filter or stop positioned between at the third lens or lens train or between the third lens or lens train and the image array sensor.

49. The method as set forth in claim 38 wherein said spectral filtering element is a Fabry-Perot filtering element and said first lens is a negative lens or lens train which substantially collimates a portion of the light before it enters the Fabry-Perot filtering element.

50. The method as set forth in claim 48 wherein said spectral filtering element is a Fabry-Perot filtering element and said first lens or lens train is negative which substantially collimates a portion of the light before it enters the Fabry-Perot filtering element.
